(19) United States
(12) Patent Application Publication
(10) Pub. No.: US 2026/0366573 A1
(43) Pub. Date: Nov. 19, 2026

(54) ADAPTER FOR A GEAR MOTOR, AND GEAR MOTOR

(71) Applicant: SEW-EURODRIVE GMBH & CO. KG, Bruchsal (DE)

(72) Inventors: Jens SCHILLINGER, Rastatt (DE); Sascha HALLER, Karlsruhe (DE)

(73) Assignee: SEW-EURODRIVE GMBH & CO. KG, Bruchsal (DE)

(21) Appl. No.: 19/478,342

(22) PCT Filed: Mar. 6, 2024
(86) PCT No.: PCT/EP2024/055820

§ 371 Date: Oct. 24, 2025

(30) Foreign Application Priority Data
Apr. 24, 2023 (DE) 102023001615.2

(51) Int. Cl. F16D 3/06; F16D 3/84; F16H 1/28

(52) U.S. Cl. CPC F16D 3/06; F16D 3/848; F16D 2300/08; F16D 2300/12; F16H 1/28

(57) ABSTRACT

An adapter for a gear motor,
wherein the adapter has a hollow adapter shaft and a hollow shaft,
wherein a clamping ring is plugged onto the hollow shaft, and a shaft can be inserted into the hollow shaft,
wherein the hollow shaft has a collar which projects radially from the hollow shaft and to which a bellows is connected in a bonded manner,
the hollow shaft has a first region in which the hollow shaft has a first internal diameter,
wherein the hollow shaft has a second region axially in front of the first region and a third region axially behind the first region, said hollow shaft having a respective second internal diameter which is smaller than the first internal diameter in the second region and in the third region,
wherein the region covered by the collar in the axial direction is axially spaced from the second and third region.

### FIELD OF THE INVENTION

The present invention relates to an adapter for a gear motor, and to a gear motor.

### BACKGROUND INFORMATION

In certain conventional systems, a gear motor has an electric motor whose rotor shaft drives a driving toothing part of a gearbox.

A gear motor is described in German Patent Document No. 10 2020 003 340.

A series of shafts and a method of manufacturing them are described in German Patent Document No. 103 16 155.

### SUMMARY

Example embodiments of the present invention provide a gear motor that is robust against production-related deformations.

According to example embodiments, an adapter for a gear motor includes a hollow adapter shaft and a hollow shaft. A clamping ring is plugged onto the hollow shaft, and a shaft can be inserted into the hollow shaft. For example, the hollow shaft can be clamped onto the shaft via the clamping ring, e.g., can be shrunk on. The hollow shaft has a collar that projects radially from the hollow shaft and to which a bellows is connected in a bonded manner, is is joined by welding and/or is welded on. The hollow shaft has a first region in which the hollow shaft has a first internal diameter, e.g., a clear inside diameter, and the hollow shaft has a second region axially in front of the first region and a third region axially behind the first region, e.g., for receiving and aligning the shaft with a precise fit, the hollow shaft having a respective second internal diameter which is smaller than the first internal diameter in the second region and in the third region. For example, the axial direction is aligned parallel to the direction of the axis of rotation of the hollow shaft. The region covered by the collar in the axial direction is axially spaced from the second and third region. For example, the region covered by the second region in the axial direction is spaced from the region covered by the collar in the axial direction, and the region covered by the third region in the axial direction is spaced from the region covered by the collar in the axial direction.

The adapter may include a bellows coupling, i.e., that the adapter shaft is connected to the hollow shaft via a bellows connected in a bonded manner. Although the heat flow introduced into the hollow shaft during welding, e.g., into the collar of the hollow shaft, causes deformation of the hollow shaft, the deformation does not impair the clamping connection between the hollow shaft and the shaft, e.g., the input shaft of the electric motor. This is because an appropriately dimensioned axial distance can be maintained between the collar and the clamping region of the force-locking connection. For this purpose, the clamping ring has an inner step so that its clear internal diameter decreases monotonically, e.g., in steps, with increasing distance from the collar, and the outer diameter of the hollow shaft is formed constantly in the region covered by the clamping ring in the axial direction.

According to example embodiments, the region covered by the collar in the axial direction is arranged within the region covered by the first region in the axial direction. An advantage of this is that the collar is arranged in the wider inner region of the hollow shaft and thus deformations of the hollow shaft caused by the heat flow of welding do not affect the clamping region.

According to example embodiments, the adapter shaft has a stepped bore into which the correspondingly stepped hollow shaft is inserted. An advantage of this is that the hollow shaft is aligned with the adapter shaft with high precision.

According to example embodiments, a sealing ring is arranged axially between the step of the stepped bore and the step of the hollow shaft. An advantage of this is that an improved compensation of misalignment errors is possible.

According to example embodiments, the sealing ring is arranged radially between the hollow shaft and the adapter shaft. An advantage of this is that an improved compensation of misalignment errors between the adapter shaft and the hollow shaft is possible.

According to example embodiments, the sealing ring is plugged onto the hollow shaft. An advantage of this is that ready production is possible. For example, the sealing ring is elastically deformed when the hollow shaft is inserted into the adapter shaft.

According to example embodiments, the collar is slanted such that the outer diameter of the collar decreases monotonically as the distance to the clamping ring decreases. An advantage of this is that the contact surface is reduced towards the clamping ring. Furthermore, deformations of the collar in the region of the slant do not affect the axial position of the clamping ring resting against the collar, as there is sufficient distance between the slant and the clamping ring.

According to example embodiments, the hollow shaft has an axially extending slot, e.g., an axial slot, which opens into the environment, e.g., at the end of the hollow shaft facing away from the adapter shaft. An advantage of this is that when the clamping ring is actuated and thus shrunk on, the hollow shaft has sufficient elasticity and can thus be shrunk onto the shaft, e.g., so that a force-locking connection is achieved between the hollow shaft and the shaft inserted into the hollow shaft.

According to example embodiments, the hollow shaft has a longitudinal groove on its inner surface, which longitudinal groove opens into the slot, e.g., the axial slot, and extends in the axial direction from the slot to the end of the hollow shaft facing the adapter shaft. For example, the region covered by the longitudinal groove in the axial direction includes the region covered by the second region in the axial direction. An advantage of this is that ventilation is effected, which, for example, makes it possible to insert the shaft into the hollow shaft.

For example, the hollow shaft and the adapter shaft, e.g., the axis of rotation of the hollow shaft and the axis of rotation of the adapter shaft, are aligned coaxially to each other.

According to example embodiments, the adapter shaft has a radially projecting collar region to which the bellows is attached in a bonded manner, e.g., is joined by welding and/or is welded on. An advantage of this is that the bellows can be arranged between the collar and the collar region. For example, the connecting surface between the collar and the bellows is a flat surface arranged at a single axial position. Similarly, the connecting surface between the collar region and the bellows is a flat surface arranged at a single axial position.

According to example embodiments, the collar region is slanted such that the outer diameter of the collar region increases monotonically as the distance to the clamping ring decreases. An advantage of this is that the contact surface with the adjacent bearing plugged onto the adapter shaft is reduced, and thus the thermally induced deformations do not affect the axial position of the bearing.

According to example embodiments, the adapter shaft has a bearing seat that is axially limited by the collar region. An advantage of this is that the collar region not only performs the function of fastening the bellows, but also the function of axial limitation.

According to example embodiments, the contact region between the clamping ring and the hollow shaft is axially spaced from the collar. For example, the clear internal diameter of the clamping ring in the contact region is smaller than in that axial region which is arranged between the region covered by the contact region in the axial direction and the region covered by the collar in the axial direction, and the clamping ring rests against the collar. An advantage of this is that the heat flow entering the collar when the bellows is welded to the collar does not affect the clamping region, as thermally induced irreversible deformations of the hollow shaft are axially spaced from the clamping region.

According to example embodiments, the shaft is the rotor shaft of the electric motor and, at the end region of the adapter shaft facing away from the rotor shaft, a sun gear of the gearbox, which sun gear has running toothing and splines, is inserted into the adapter shaft with its splines.

An advantage of this is that the rotor shaft drives the sun gear and thus drives the gearbox, and the sun gear is aligned coaxially with the rotor shaft via the adapter shaft and hollow shaft.

Further features and aspects of example embodiments of the present invention are explained in more detail below with reference to the appended schematic Figures.

### BRIEF DESCRIPTION OF THE DRAWINGS

FIG. 1 is a cross-sectional view of an adapter of a gear motor.

FIG. 2 is a perspective view of an adapter shaft 1 and a hollow shaft 9 of the adapter connected to the adapter shaft 1 via a bellows 5.

FIG. 3 is a perspective view of the adapter shaft 1 together with the hollow shaft 9.

In FIG. 4, in contrast to FIG. 2, a clamping ring 6 is illustrated as being pushed onto the hollow shaft 9.

FIG. 5 is a perspective view of a section of the adapter.

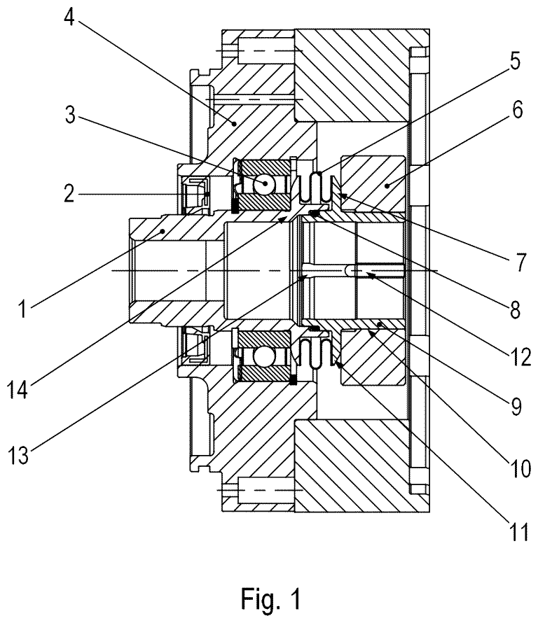

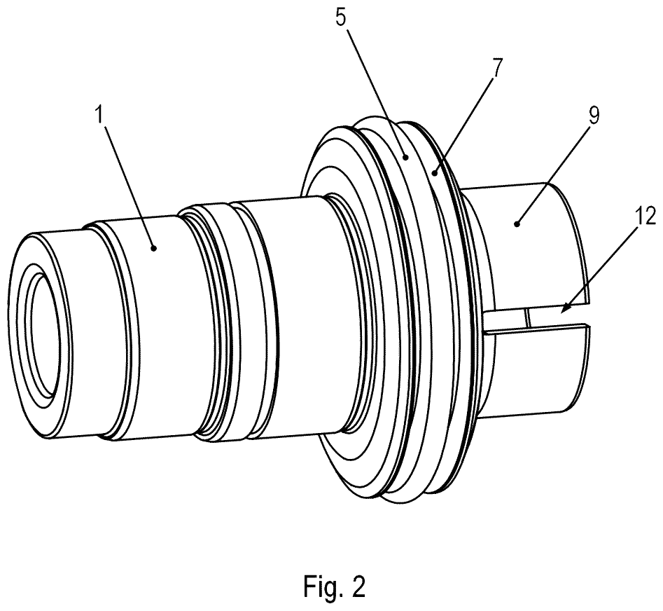

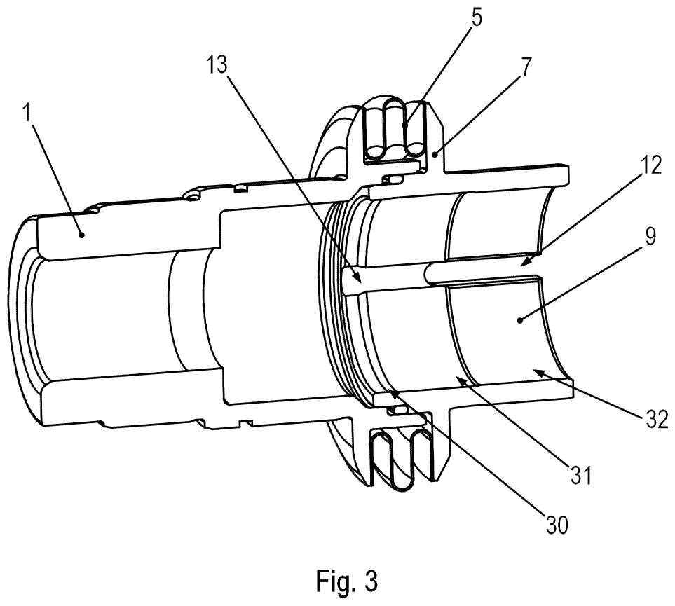

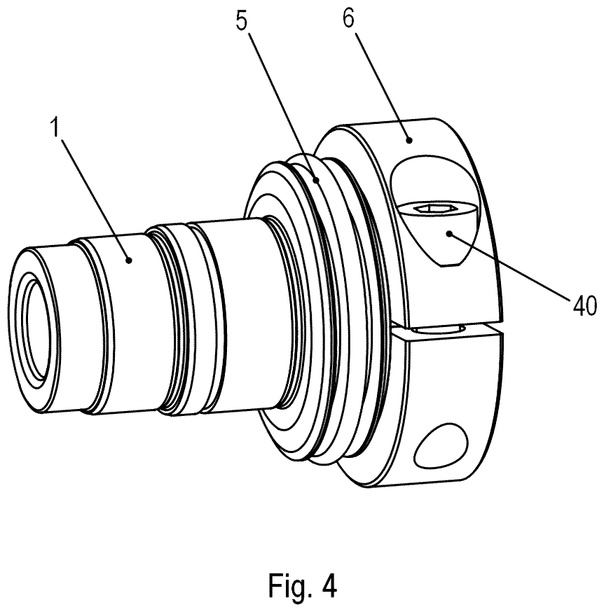

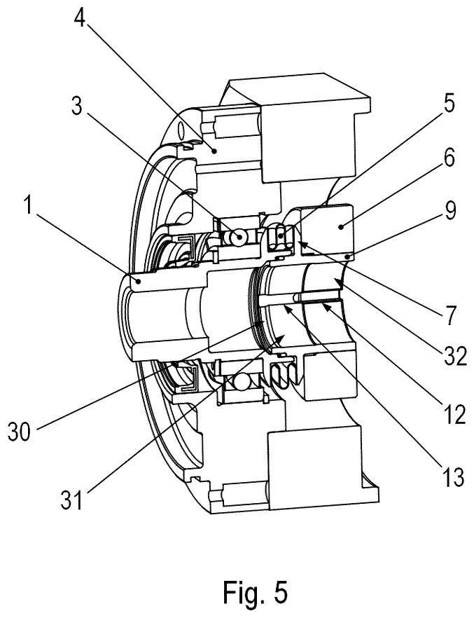

### DETAILED DESCRIPTION

As illustrated in the Figures, the adapter has an adapter shaft 1 that is hollow.

Thus, a sun gear of a planetary gear of the gear motor, which sun gear has a running toothing and a spline arranged axially in front of the running toothing, can be inserted into the adapter shaft 1 with the spline. The spline is cut into the material of the adapter shaft 1 and thus the sun gear is connected to the adapter shaft in a form-fitting manner, e.g., connected for conjoint rotation.

The adapter shaft 1 has a stepped bore at its end region facing axially away from the sun gear, and a correspondingly stepped hollow shaft 9 is inserted.

A sealing ring 8 is arranged axially between the step on the outside of the hollow shaft 9 and the step of the adapter shaft 1. Axially in front of and axially behind the sealing ring 8, the hollow shaft 9 is, for example, received with a clearance fit or a precise fit in the adapter shaft 1.

On its radially outer surface, the hollow shaft 9 has a collar 7 that projects radially outwards and is formed continuously in the circumferential direction. The hollow shaft together with its collar 7 is formed as a single part, e.g., as a single piece.

The adapter shaft 1 also has a collar region 14 that projects radially outwards and is formed continuously in the circumferential direction, which axially limits a bearing seat onto which a bearing 3 of the adapter shaft is plugged, which bearing 3 is received in an adapter housing 4. For example, the inner ring of the bearing 3 is positioned against the collar region 14 of the adapter shaft 1.

A bellows 5 is connected in a bonded manner, e.g., welded on, to the collar region 14, which bellows 5 is also connected in a bonded manner, e.g., is welded on, to the collar 7.

A clamping ring 6 is plugged onto the hollow shaft 9, which clamping ring 6 has a continuous slot region through which a clamping screw 40 projects. The clamping ring is shrunk onto the hollow shaft by operating the clamping screw 40.

The bellows 5 is arranged radially outside the sealing ring 8. The region covered by the bellows 5 in the axial direction includes the region covered by the sealing ring 8 in the axial direction.

The clamping ring 6 is positioned against the collar 7 and is thus limited in the axial direction. The inner ring of the bearing 3 is limited by the collar region 14 in the opposite axial direction.

The hollow shaft 9 has a radially continuous axial slot 12, e.g., which thus extends in the axial direction and is formed open to the environment at the axial end of the hollow shaft 9 facing away from the adapter shaft 1.

When the clamping ring 6 is shrunk on, the hollow shaft 9 can thus be elastically deformed.

The hollow shaft 9 is aligned coaxially to the adapter shaft 1.

On its inner surface, the hollow shaft 9 has a longitudinal groove 13, e.g., a channel, which extends axially from the axial slot 12 to the end of the hollow shaft 9 facing the adapter shaft 1. The longitudinal groove 13 is thus, for example, in alignment with the axial slot 12.

The longitudinal groove 13 has only a shallow groove depth, as it is arranged as a venting channel.

For example, the longitudinal groove 13 is produced with the same tool that produces the axial slot 12.

The clamping ring 6 is plugged onto the hollow shaft 9 and contacts the hollow shaft in the clamping contact region 10. For example, the shrink force generated by the clamping ring 6 is introduced into the hollow shaft 9.

The clamping ring 6 projects beyond the clamping contact region 10 in the axial direction towards the collar 7. Thus, the region covered by the clamping ring 6 in the axial direction contains the region covered by the clamping contact region 10 in the axial direction, which is, however, axially spaced from the region covered by the collar 7 in the axial direction.

Thus, the clamping contact region 10 is axially spaced from the collar 7.

When the bellows 5 is welded to the hollow shaft 9, a heat flow penetrates from the collar 7 into the rest of the hollow shaft 9. Before a sufficiently large spread of the heat flow is achieved, deformations of the hollow shaft 9 can be effected.

For this reason, the hollow region of the hollow shaft 9 has a first region 31 with a first clear internal diameter, which is arranged axially between two further regions (30, 32), each with a second clear internal diameter.

The first region 31 is arranged axially between the two further regions (30, 32). For example, the two further regions (30, 32) are adjacent to the first region 31.

A shaft, e.g., the rotor shaft of the electric motor, pushed into the hollow shaft 9 is received with a precise fit in the two second regions (30, 32) and has radial play relative to the first internal diameter of the first region 31.

The first internal diameter is thus larger than the second internal diameter.

The above information on the internal diameters refers to the hollow shaft 9 before the welded connection between bellows 5 and collar 7 is made. The above-mentioned heat input during welding causes deformations which can cause a deviation from the first internal diameter in the first region 31, so that radially directed projections can occur in the first region 31. The radial distance between the hollow shaft 9 and the first region 31 is selected such that the protrusions are smaller than the radial distance. Thus, the heat-induced radially inward protrusions caused by the welding process are rendered harmless within the radial play between the hollow shaft 9 and the shaft.

During the welding, the clamping ring 6 is not yet pushed onto the hollow shaft 9.

The shaft is received and aligned in the two regions 30 and 32 with a precise fit.

The region 32, for example, extends in the axial direction in the same manner as the clamping contact region 10. Thus, the clamping force from the clamping ring 6 is applied to the shaft as directly as possible via the hollow shaft 9 in the region 32.

The collar 7 is arranged axially between the bellows 5 and the clamping ring 6.

Like the region 32, the region 30 is axially spaced from the collar 7.

The region covered by the further region 30 in the axial direction is arranged within the region covered by the bellows 5 in the axial direction.

The hollow shaft 9 has a first outer region in its stepped region, which outer region has a first outer diameter, and a second outer region, which has a second outer diameter that is larger than the first outer diameter.

The first outer region rests against a first region of the adapter shaft 1, which region has a first clear internal diameter, and the second outer region of the hollow shaft 9 rests against a second region of the adapter shaft, which region has a second clear internal diameter. The second clear internal diameter of the adapter shaft 1 is larger than the first clear internal diameter.

The sealing ring 8 is arranged axially between the step of the adapter shaft 1 and the step of the hollow shaft 9. The sealing ring 8 is dimensioned and arranged between the hollow shaft 9 and the adapter shaft 1 such that it is elastically deformed. Its axial spacing from the collar 5 and also from the collar region 14 also protects it from critically high temperatures.

The shaft, for example, projects through the hollow shaft 9 into the adapter shaft 1. Although this adapter shaft 1 is hollow throughout, the sun gear with its spline is inserted into the end of the adapter shaft facing away from the hollow shaft 9. Thus, when the shaft is inserted into the slot 12, the longitudinal groove 13 diverts excess pressure to the environment.

The first region 31 is internally cylindrical and has the clear internal diameter, e.g., the first internal diameter.

The second region 32 is internally cylindrical and has the clear internal second diameter, e.g., the second internal diameter.

The third region 30 is internally cylindrical and also has the clear second diameter, e.g., the second internal diameter, which is smaller than the first.

The collar 7 has a conical slant so that the outer diameter decreases with decreasing axial distance from the clamping ring 6, e.g., decreases monotonically. In this manner, the bellows 5 can be attached to an end surface of the collar 7 that is as large as possible.

In certain arrangements, the bellows 5 is not welded, but is connected in some other bonded manner, e.g., by adhesive bonding.

### LIST OF REFERENCE NUMERALS

1 Adapter shaft
2 Shaft sealing ring
3 Bearing
4 Adapter housing
5 Bellows
6 Clamping ring
7 Collar
8 Sealing ring
9 Hollow shaft
10 Clamping contact region
11 Conical slant
12 Axial slot
13 Longitudinal groove, e.g., channel
14 Collar region
30 Region with second internal diameter
31 Region with first internal diameter
32 Region with second internal diameter
40 Clamping screw

1-15. (canceled)

16. An adapter for a gear motor, comprising:
a hollow adapter shaft;
a hollow shaft adapted to receive a shaft and including a radially-projecting collar, a first region having a first internal diameter, a second region axially in front of the first region, and a third region axially behind the first region, the second region and the third region having a second internal diameter that is smaller than the first internal diameter;
a clamping ring arranged on the hollow shaft; and
a bellows connected in a bonded manner and/or welded to the collar;
wherein a region covered by the collar in an axial direction is axially spaced from the second region and the third region.

17. The adapter according to claim 16, wherein the clamping ring is adapted to clamp the hollow shaft onto the shaft, and the shaft projects through the hollow shaft and/or projects through the hollow shaft and projects at least partially into the adapter shaft.

18. The adapter according to claim 16, wherein the shaft has a constant outer diameter in a region covered by the first region, the second region, and the third region in the axial direction, the axial direction is aligned parallel to a direction of an axis of rotation of the hollow shaft, the region covered by the second region in the axial direction is spaced from the region covered by the collar in the axial direction, and the region covered by the third region in the axial direction is spaced from the region covered by the collar in the axial direction.

19. The adapter according to claim 16, wherein the region covered by the collar in the axial direction is arranged within the region covered by the first region in the axial direction.

20. The adapter according to claim 16, wherein the adapter shaft has a stepped bore and the hollow shaft is stepped, the hollow shaft being arranged in the stepped bore.

21. The adapter according to claim 20, wherein a sealing ring is arranged axially between a step of the stepped bore and a step of the hollow shaft.

22. The adapter according to claim 21, wherein the sealing ring is arranged radially between the hollow shaft and the adapter shaft.

23. The adapter according to claim 21, the sealing ring is arranged on the hollow shaft.

24. The adapter according to claim 16, wherein the collar is slanted, and an outer diameter of the collar decreases monotonically with a decreasing distance to the clamping ring.

25. The adapter according to claim 16, wherein the hollow shaft includes an axially extending slot that opens to the environment.

26. The adapter according to claim 16, wherein the hollow shaft includes an axially extending slot that opens to the environment at an end of the hollow shaft facing away from the adapter shaft.

27. The adapter according to claim 25, wherein an inner surface of the hollow shaft includes a longitudinal groove that opens into the slot and extends in the axial direction from the slot to an end of the hollow shaft facing the adapter shaft.

28. The adapter according to claim 27, wherein a region covered by the longitudinal groove in the axial direction includes the region covered by the second region in the axial direction.

29. The adapter according to claim 16, wherein (a) the hollow shaft and the adapter shaft and/or (b) an axis of rotation of the hollow shaft and an axis of rotation of the adapter shaft are aligned coaxially to each other.

30. The adapter according to claim 16, wherein the adapter shaft includes a radially projecting collar region to which the bellows is attached in a bonded manner and/or welded.

31. The adapter according to claim 30, wherein the collar region is slanted, and an outer diameter of the collar region increases monotonically with decreasing distance to the clamping ring.

32. The adapter according to claim 30, wherein the adapter shaft includes a bearing seat that is axially limited by the collar region.

33. The adapter according to claim 16, wherein a contact region between the clamping ring and the hollow shaft is axially spaced from the collar.

34. The adapter according to claim 33, wherein a clear internal diameter of the clamping ring in the contact region is smaller than in an axial region that is arranged between a region covered by the contact region in the axial direction and the region covered by the collar in the axial direction.

35. A gear motor, comprising:
a gearbox including a sun gear having a running toothing and splines;
an electric motor including a rotor shaft;
an adapter as recited in claim 16;
wherein the shaft is the rotor shaft of the electric motor and, at an end region of the adapter shaft facing away from the rotor shaft, the splines of the sun gear are arranged in the adapter shaft.
